(19) United States
(12) Patent Application Publication
(10) Pub. No.: US 2006/0095743 A1
(43) Pub. Date: May 4, 2006

(54) Vliw processor with copy register file

(75) Inventors: Balakrishnan Srinivasan, Eindhoven (NL); Marco Jan Gerrit Bekooij, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/535,782

(22) PCT Filed: Oct. 28, 2003
(86) PCT No.: PCT/IB03/04824

§ 371 Date: May 20, 2005

(30) Foreign Application Priority Data
Nov. 20, 2002 (EP) 02079815.3

(51) Int. Cl. G06F 9/44

(52) U.S. Cl. 712/228

(57) ABSTRACT

A compute program is executed in a VLIW processor, which contains a plurality of functional units and a plurality of register files that are each coupled to a respective subset of the functional units. When a first instruction is executed that results in writing of a result to a register file in a register addressed by a result address from the first instruction, the result is copied to a copy register in a register file. The copy register is selected dependent on the register file to which the result was written, but at least partially independent of the result address, so that results written to different addressed registers in the register file are copied to the same register in the copy file. Subsequently a copy instruction may be executed to copy the result from the copy register file to a second register file, from which the result may be used as operand of another instruction.

The invention relates to a data processing device with instruction words that contain instructions for a plurality of functional units in parallel, such as a Very Large Instruction Word (VLIW) processing device.

VLIW processors contain a plurality of functional units that are capable of executing instructions from a program. The instructions are issued as instruction words that contain instructions for a plurality of functional units in parallel. Operand data is passed between the functional units by means of register files. Each register file contains a set of registers and a number of read and write ports for accessing selected registers. Each functional unit (or group of functional units) is coupled to a different set of ports. Thus, a functional unit is able to read operands produced by other functional units and to write results for use by the other functional units.

In practice a VLIW processor may contain a very large number of functional units. This makes it impracticable to couple all functional units to a single register file. As an alternative architecture it has been proposed to group the functional units into clusters. For each cluster a register file is provided, so that all functional units in a cluster are coupled to ports of this cluster. In this architecture the results produced by a particular functional unit can only be read from the register file by functional units that belong to the same cluster as the particular functional unit. The idea behind this is that instructions from different tasks that require exchange of results are generally executed only by subsets of the functional units, i.e. functional units in a particular cluster. Therefore no connections to register files outside the cluster are needed for those tasks.

Nevertheless, there sometimes remains a need to exchange a limited number of operands and results between functional units in different clusters. Various solutions have been proposed to transport data from one register file to another, so that results produced by functional units in one cluster can be made available to functional units in another cluster.

U.S. Pat. No. 6,269,437 discloses processor with a plurality of register files and a duplicator. The duplicator executes instructions which specify source and target registers in different register files. The duplicator is coupled to read and write ports of the register files. In response to the instructions the duplicator copies data from the source registers to the target registers.

When a program for the processor is compiled the compiler generates a collection of instructions for the various functional units and determines dependency relations between instructions that produce and use certain results respectively. The compiler determines when such a dependency relation exists between instructions that are executed by functional units that do not belong to the same cluster (are not coupled to ports of a common register file). In this case, the compiler generates an instruction for the duplicator to copy the result of the producing instruction to a register in a register file that is coupled to the functional unit that executes the using instruction.

This technique imposes additional scheduling constraints on the generation of instruction words. After execution of the producing instruction, the copy instruction has to be scheduled, followed by the using instruction. The registers involved must remain allocated at least until the relevant instructions have been executed. This reduces the efficiency of the processor.

Among others, it is an object of the invention to provide for increased efficiency of a data processing device with a plurality of functional units that can execute instructions from an instruction word in parallel, using registers distributed over different register files.

The data processing device according to the invention is set forth in claim 1. According to the invention a special copy register file is provided which acts a source of operands for a copy functional unit. Results that are written to registers in register files are copied to the copy register file as part of execution of the instructions that produce the results, i.e. without requiring additional instructions. The copy functional unit is controlled by instructions from the instruction words. The instructions for the copy functional unit indicate which results need to be copied from the copy register file to other register files.

Preferably, wherein the copy register file is coupled to at least part of the ports of the register files via a port coupling link, arranged to copy data written to respective ones of the ports each to a respective register in the copy register file, the respective register being selected dependent on the respective one of the ports but at least partially irrespective of the register address with which the data is supplied to the respective one of the ports. Thus, only a limited number of copy registers is needed in the copy register file per source register file, less than the total number of registers in the source register file. Preferably, the copy register is selected completely independent of the register address.

In principle, each result that is written to a normal register file may automatically be copied to the copy register file. However, this may lead to overwriting of previous results that need to be copied from the copy register file. To limit prevent unneeded copying an embodiment of the data processing apparatus according uses instructions that comprises a field for indicating whether a result of the at least one of the instructions must be copied to the copy register file, the port coupling link being arranged to copy the data dependent on a value in said field. Thus, unnecessary overwriting can be prevented by the program, leaving more time for copy instructions for copying from the copy register file.

A primary application of the invention is copying of results between register files for functional units that do not have ports coupled to the same register file. A further application is reduction of pressure on register use, i.e. temporary saving of data outside a register file, so as to make registers in the register file available for other data. In this case the copy register file is used to save a result that is overwritten in the register file to which it was originally written, the result being written back to that register file later when the result is needed. Writing back may be performed directly from the copy register file, or after storage in or in another register file.

These and other objects and advantageous aspects of the data processing device, method of data processing and method of compiling instruction words will be set forth using the following figures.

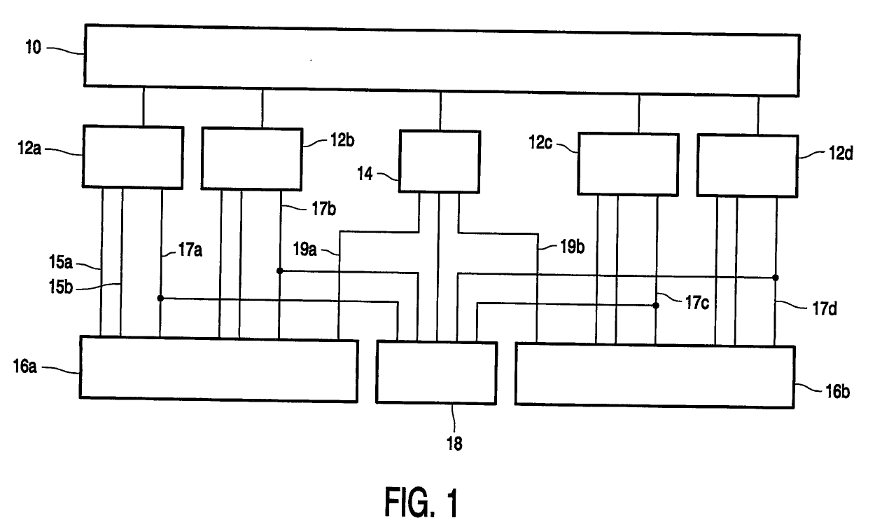

FIG. 1 shows a data processing device

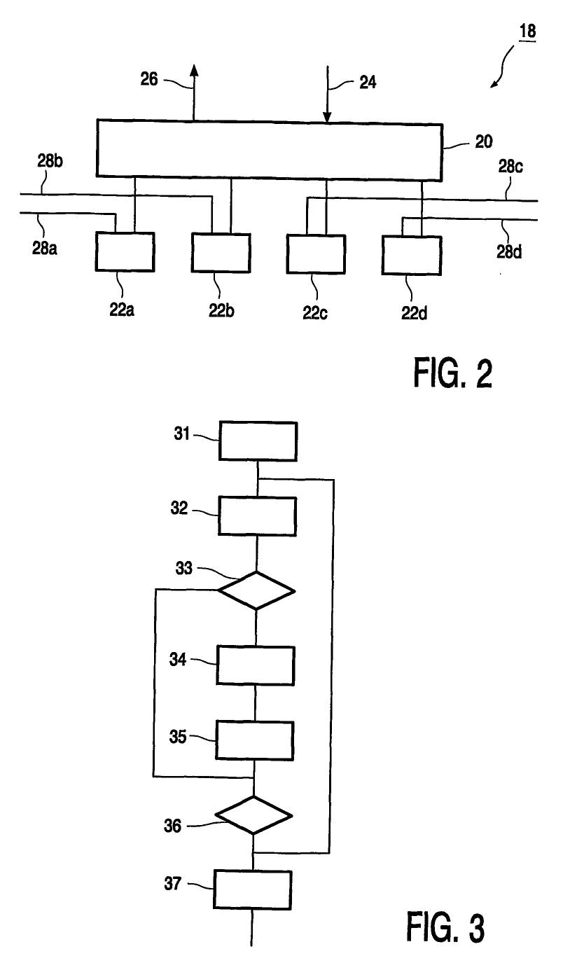

FIG. 2 shows a copy register file

FIG. 3 shows a flow chart for generating a program for the processing device

FIG. 1 shows a data processing device with an instruction issue unit 10, functional units 12a-d, a copy functional unit 14, register files 16a,b and a copy register file 18. Instruction issue unit 10 has issue slot connections coupled to the functional units 12a-d and the copy functional unit 14. Instruction issue unit 10 is designed to issue instruction words that each contain a combination of instructions, each for a respective one of the functional units 12a-d and the copy functional unit 14. For this purpose, instruction issue unit 10 generally contains an instruction memory, a program counter and optional instruction decompression circuitry, but since these are well known and not relevant to the invention they are not shown separately.

A first and second functional unit 12a,b have operand inputs coupled to read ports 15a,b of a first register file 16a. First and second functional unit 12a,b have result outputs ports coupled to write ports 17a,b of first register file 16a. Similarly, a third and fourth functional unit 12c,d have operand inputs coupled to read ports of a second register file 16b. Third and fourth functional unit 12c,d have result outputs coupled to write ports 17c,d of second register file 16b. The read and write ports comprise a register addressing part (not shown separately) to address registers in the register files 12a,b under control of register selection fields in the instructions. The read ports each comprise a register content connection (not shown separately) for feeding contents of an address register to a functional unit 12a-d. The write ports each comprise a result connection (not shown separately) for feeding a result from a functional unit 12a-d to the register file 16a,b.

Functional units 12a-d may be of any type, such as for example Arithmetic Logic Units (ALU), or memory access units etc. Although only a limited number of functional units has been shown, it will be understood that in practice many more functional units may be provided. Similarly, a greater number of register files may be provided. As shown, each register file 12a,b defines a cluster of functional units 12a-d that is connected to the register file. By way of example, each functional unit 12a-d is coupled to one register file only, but it should be understood that, by means of register file selection hardware some functional units 12a-d may have their inputs and/or outputs coupled to more than one register file 16a,b, so that registers in any one of those register files may be selected for reading and/or writing from those functional units under control of instructions. However, preferably each functional unit 12a-d is coupled to one register file only, since connection to multiple register files increases the number of required ports, instruction width, hardware costs and delay.

Although the invention will be described in terms of functional units 12a-d, it will be understood that one or more of functional units 12a-d may be replaced by a group of functional units that share the same read and write ports and execute instructions alternatively.

Copy register file 18 has inputs coupled to each of the write ports 17a-d of register files 16a,b. Copy register file furthermore has a read port connected to an operand input of copy functional unit 14. Copy functional unit 14 has result outputs 19a,b coupled to respective ones of register files 16a,b.

In operation, instruction issue unit 10 issues instruction words that each contain a combination of instructions, each for a respective one of the functional units 12a-d and the copy functional unit 14. The instructions for functional units 12a-d typically contain an operation code, a first and second operand register selection code and a result register selection code. The operation code commands the functional unit to select a specific operation type and the operand register selection codes and result register selection codes are supplied to the ports of the register files to select operand and result registers respectively.

When results are written into register files 16a,b at least some of the results are automatically copied into registers of copy register file 18. Copy functional unit 14 executes instructions to copy contents of registers in copy register file 18 to addressed registers in register files 16a,b.

Instructions for copy fuictional unit 14 typically contain an address of an operand register in copy functional unit 18 that contains operand data and a specification of a result register to which the data should be copied. The specification of the result register typically contains a register file selection field and a register selection field, for addressing a selected register file 16a,b and a register in that register file 16a,b respectively. In response to the instruction data is copied from the addressed register with operand data to the addressed register in the selected register file 16a,b (it should be realized that in practice there will be many more than two register files 16a,b to select from).

Thus, execution of copy instructions issued by instruction issue unit 10 to copy functional unit 14 may be used to make a result of an operation executed by an originating functional unit 12a-d available for use as operand by a using functional unit 12a-d that is not coupled to the same register file 16a,b as the originating functional unit 12a-d.

In an alternative embodiment, copy functional unit 14 copies to predetermined registers in register files 16a,b. In this case no result register address is needed in instructions for copy functional unit 14. Also, copy functional unit 14 may broadcast the copies to all register files 16a,b in parallel. In this case no register file selection field is needed in instructions for copy functional unit 14, but, of course, this may lead to needless register overwriting in many applications where the copy is needed in only one or part of the register files 16a,b.

FIG. 2 shown an embodiment of copy functional unit 18 (shown in FIG. 1). This embodiment contains a multiplexer 20 and a plurality of registers 22a-d. The data part of write port 17a-d of the register files 16a,b are coupled to inputs 28a-d of respective ones of registers 22a-d. Outputs of registers 22a-d are coupled to an operand input 26 of copy functional unit 14 (not shown) via multiplexer 20. A control input 24 is used for receiving operand addresses from copy instructions for copy functional unit 14.

In operation, when a functional unit 17a-d writes a result to a write port 17a-d, the result is automatically also written into the register 22a-d for that write port 17a-d. Under control of copy instructions operand data from selected ones of registers 22a-d is supplied to the operand input 26 of copy functional unit 14.

It will be realized that all data from a particular write port 17a-b is copied to the same register 22a-d for that particular write port 17a-b in copy register file 18, irrespective of the selected register in the register file 16a,b of the write port 17a-d. Thus, the number of registers 22a-d in copy register file 18 is much smaller than the sum of the numbers of registers in register files 16a-d, so that registers 22a-d in copy register file 18 can be addressed with a small address field. The price for this is that, without further measures, the content of registers 22a-d must be copied to the other register files 16a,b before it is overwritten.

Preferably, the instruction words from instruction issue unit 10 control whether or not result data is copied into registers 22a-d in copy register file 18. This may be realized for example by augmenting instructions for functional units 12a-d with copy control information, such as a copy control bit in each particular instruction to indicate whether or not the result of the particular instruction should be copied to the relevant register 22a-d in copy functional unit 18 when the functional unit 12a-d writes the result of the particular instruction to its register file 16a,b. In this case, the copy control bit for the particular instruction is fed to a write enable input (not shown in FIG. 2) of the register 22a-d for the write port 17a-d of the functional unit 12a-d that executes the instruction. Use of the copy control bits makes it possible to delay overwriting of data in registers 22a-d, so that the instruction for copy functional unit 14 to copy the data form a register 22a-d may be delayed, for example when data from another register 22a-d must be copied first.

In an alternative embodiment each register 22a-d of copy register file 18 for a write port 17a-d may be replaced by a plurality of registers. In this case, copy instructions for copy functional unit contain selection codes for selecting among the pluralities of registers for the respective write ports 17a-d. Results from write ports 17a-d are copied into different ones of this plurality of registers for the write port 17a-d in round robin fashion. Thus, overwriting of data in registers 22a-d is delayed even without copy control bits.

Although separate registers 22a-d have been shown for respective ones of write ports 17a-d, shared registers (or sets of registers) may be provided for groups of write ports, for example all write ports of a register file 16a,b. In each instruction cycle data from only one of the group of write ports 17a-d is written to the register (or one of the registers) for the group of write ports. This reduces the number of connections to registers in copy register file 18. By means of copy control bits, for example, it may be controlled from which of the write ports in the relevant group of write port data is copied.

As an alternative, separate registers 22a-d may be provided for different groups of registers in the same register file. In this case, a part of the register address which is supplied to the write port 17a-d is also supplied to the copy register file 18 to select the appropriate register 22a-d in the copy register file 18. This reduces the average frequency with which the registers 22a-d in the copy register file 18 are overwritten, giving copy functional unit 16 more time to copy data. By adapting the allocation of registers to different results during a compilation phase so that later needed data is not overwritten in copy register file 18 it can be ensured that this data remains available. The entire register address is not needed for this purpose: only a subset of e.g. one or more of the bits suffices to select a register in copy register file 18 for this purpose.

FIG. 3 shows a flow-chart of a process for generating instruction words for the processing device of FIG. 1. Such a process for generating instructions may be executed by any computer, including the device of FIG. 1. The process results in a set of instruction words stored in instruction issue unit 10 for execution by functional units 12a-d and copy functional unit 14, possibly after intermediate storage on some medium such as a magnetic or optical disk.

In a first step 31 a specification of a program is received in some form or another, for example in a high level language such as C. In the first step this program is converted into a specification of set of machine operations that have to be executed by functional units 12a-d to implement the program and a specification of the data dependencies between these operations. In a second step 32, the operations are assigned to fuictional units 12a-d and scheduled by assignment to different instruction words. In general not all functional units 12a-d are capable of executing all operations, therefore assignment of operation to functional units 12a-d is constrained by the capabilities of the functional units 12a-d. Furthermore, assignment is directed to distribute instructions over different functional units so as to minimize the number of instruction words that need to be executed. In addition second step 32 assigns registers the results of the operations.

In third, fourth and fifth steps 33, 34, 35 the instructions in the instruction words are processed one by one to ensure availability of the operands of the instructions. In a fourth step it is tested whether the functional unit 12a-d that produces the operand of the instruction is coupled to the same register file as the functional unit 12a-d that executes the instruction. If so, the operand of the instruction is set to point to the relevant register. If not, fourth step 35 is executed, allocating an intermediate register in the register file 16a,b of the functional unit 12a-d that has to execute the instruction. The operand of the instruction is set to point to the intermediate register. The fourth step 35 adds a copy instruction in an instruction word to command copy functional unit 14 to copy the operand from copy register file 18 to the intermediate register. A fifth step 36 sets the copy control bit of the instruction that produces the operand as its result, so that the result is written into copy register file 18. A sixth step 37 tests whether all instructions have been processed. If not, third to fifth steps 33-35 are repeated. If so, a seventh step 37 is executed, assembling the program and storing it in a computer readable medium such as an addressable semi-conductor memory in instruction issue unit 10 or an intermediate medium.

It will be appreciated that FIG. 3 shows merely the steps most directly involved with the invention. In practice many more steps may be added whose implementation is known per se. If necessary, for example, rescheduling steps may occur so as to ensure sufficient time for copy functional unit 14 to copy data, or to ensure free availability of sufficient registers.

Although the invention has been described applied to copying of results between register files for functional units that do not have ports coupled to the same register file, it should be realized that the invention is more generally applicable. For example, copying may be used to reduce pressure on register use. In this case the copy register file is used to save a result that is overwritten in the register file to which it was originally written, the result being written back to that register file later when the result is needed. Writing back may be performed directly from the copy register file, or via memory etc. Thus if a value in a source register file is no longer needed in a particular register file after a copy operation, the register can be reused for other data since a copy can be made to another register file at a later point.

1. A data processing device comprising
a plurality of functional units;
a plurality of register files, each with ports coupled to the functional units from a respective cluster of the functional units;
an instruction word issue unit for issuing an instruction word to the functional units, the instruction word being capable of comprising a combination of instructions for execution in a common instruction cycle by respective ones of the functional units respectively;
a copy register file, coupled to the register files, for receiving a copy of data written into any one of the register files in response to writing of said data into that register file;
a copy functional unit coupled to the copy register file, the copy functional unit being arranged for executing an instruction from the instruction word to copy a content of a register from the copy register file to an addressed register in the register files.

2. A data processing apparatus according to claim 1, wherein the copy register file is coupled to at least part of the ports of the register files each via a respective port coupling link, arranged to copy data written to respective ones of the ports each to a register in a respective set of one or more registers in the copy register file, the respective set being selected dependent on the respective one of the ports, selection of the register in the set, if any, being at least partially irrespective of the register address with which the data is supplied to the respective one of the ports.

3. A data processing apparatus according to claim 2, wherein at least one of the instructions comprises a field for indicating whether a result of the at least one of the instructions must be copied to the register in the respective set of one or more registers for the port to which the at least one of the instructions writes the result, the port coupling link being arranged to control whether or not data is copied, under control of a value in said field.

4. A method of compiling a computer program for a processor with a plurality of functional units, and a plurality of register files that each have ports coupled to a respective cluster of functional units according to claim 1, the method comprising
generating instructions for implementing a task;
assigning each instruction to a respective functional unit;
determining whether a first one of the instructions executed by a first one of the functional units requires a result produced by a second one of the functional units that does do not belong to a same one of the clusters as the first one of the functional units;
adding a copy instruction for a copy functional unit to copy the result from a copy register file to a first one of the register files which has a read port coupled to the first one of the functional units;
storing the program with instruction words containing the instructions and the copy instruction in a computer readable medium, for use in execution by the processor.

5. A method according to claim 4, comprising updating a second one of the instructions whose execution by the second one of the functional unit results in said result to cause copying of the result to the copy register file when the result is written to a second one of the register files, said updating setting a copy control field in the second one of the instructions which enables copying to the copy register file.

6. A computer program product comprising instructions for a processing device according to claim 1, the instructions comprising a first instruction for generating a result and writing the result to a first register file with a copy being written to a copy register file as part of execution of the first instruction, a second instruction for copying the result from the copy register file to a second register file, and a third instruction which uses the result from the second register file.

7. A method of executing a program, the method comprising
executing a first instruction with a first functional unit that produces a result and writes that result to a first register file in a first register addressed by a result address from the first instruction, and a copy of the result to a copy register that is selected in a copy register file at least partially independent of the result address;
executing a copy instruction to copy the result from the copy register file to a second register file;
executing a second instruction with a second functional unit, using the result as operand from the second register file.

8. A method according to claim 7, wherein the copy register is selected dependent on the port to which the result is written to the first register file.

9. A method according to claim 7, wherein copy control information from the first instruction is tested to determine whether or not the result is copied to the copy register file.
